(19) United States
(12) Patent Application Publication
(10) Pub. No.: US 2009/0307138 A1
(43) Pub. Date: Dec. 10, 2009

(54) Innovation Marketplace Systems

(76) Inventor: Bart E. Steiner, Phoenix, AZ (US)

Correspondence Address: Stoneman Volk Patent Group, 3770 NORTH 7TH STREET, Suite 100, PHOENIX, AZ, 85014, US

(21) Appl. No.: 12/476,351

(22) Filed: Jun. 2, 2009

Related U.S. Application Data
(60) Provisional application No. 61/059,240, filed on Jun. 5, 2008.

(51) Int. Cl. G06Q 30/00; G06Q 99/00; G06F 21/00; G06Q 50/00

(52) U.S. Cl. 705/51; 705/1; 705/26; 705/80

(57) ABSTRACT

This invention relates to a ready system for providing secure innovation-maturation marketplace systems that increase innovation-maturation efficiencies while safely exposing innovative concepts to expert-ranking information, and while providing expert-innovation rankers with opportunities to enhance and monetize their innovation ranking-credentials.

### CROSS-REFERENCE TO RELATED APPLICATION

The present application is related to and claims priority from prior U.S. provisional application Ser. No. 61/059,240, filed Jun. 05, 2008, entitled “INNOVATION MARKETPLACE SYSTEMS”, the contents of which are incorporated herein by this reference and are not admitted to be prior art with respect to the present invention by the mention in this cross-reference section.

### BACKGROUND

This invention relates to improved innovation marketplace systems. More particularly, this invention relates to a ready system for providing innovation-maturation marketplaces. Further, importantly, this invention relates to providing a ready enabling system for innovation-maturation marketplaces that decrease innovation-maturation time-periods by providing quality, safe, exposure of innovative concepts, maturing these innovative concepts, and offering them into broader marketplaces. Additionally, importantly, this invention relates to a ready system for providing expert-ranking information. Still further, this invention relates to a ready system for providing and monetizing innovation ranking-credentials associated with innovation rankers.

Presently, innovation-maturation marketplace systems do not comprise, for example, innovation-maturation marketplace systems providing quality, safe, exposure of innovative concepts, maturing these innovative concepts, and offering them into broader marketplaces. In addition, presently, innovation marketplace systems do not comprise, for example, a system for providing expert-ranking information. Additionally, present innovation marketplace systems do not comprise, for example, a system for providing and monetizing innovation ranking-credentials associated with innovation rankers. Further, presently, innovation marketplace systems do not allow for innovator control of the innovation.

Thus, a need exists for innovation-maturation marketplace systems that decrease innovation-maturation time-periods while safely exposing innovative concepts to expert-ranking information, and while providing expert-innovation rankers with opportunities to enhance and monetize their innovation ranking-credentials, while leaving control of the innovation with the innovator.

### OBJECTS AND FEATURES OF THE INVENTION

A primary object and feature of the present invention is to provide an innovation marketplace system with an online innovation community, which addresses the particular needs of inventors.

A further object and feature of the present invention is to provide such innovation marketplace system where privacy of innovation information is under the control of the inventor.

Another object and feature of the present invention is to provide such an innovation marketplace system with customizable privacy of innovation information.

Yet another object and feature of the present invention is to provide such an innovation marketplace system that assists in establishing privacy contracts before disclosure of information.

A further object and feature of the present invention is to provide such an innovation marketplace system where a custom privacy agreement may be used.

Another object and feature of the present invention is to provide such an innovation marketplace system that encrypts secured documents during transmittal to authorized users.

Another primary object and feature of the present invention is to provide innovation-maturation marketplace systems for decreasing innovation-maturation time-periods and providing quality, safe exposure of innovative concepts, which allow the maturing of these innovative concepts, and offering them into broader marketplaces.

It is a further object and feature of the present invention to provide ready innovation marketplace systems for providing expert-ranking information innovation rankers.

It is a further object and feature of the present invention to provide ready innovation marketplace systems for monetizing innovation ranking-credentials associated with the innovation rankers.

Another object and feature of the present invention is to provide such innovation marketplace system that facilitates user-controlled communication and action-initiated notifications between and to inventors, experts, users with skills, users with resources and companies.

A further object and feature of the present invention is to provide such an innovation marketplace system that enables the formation, cultivation and control of user-initiated, user-approved relationships between innovators, experts, users with skills, users with resources and companies.

Yet another object and feature of the present invention is to provide such innovation marketplace system that provides for community-ranking of contributions made to innovations such that these rankings serve both to reward the contributing community member and enable a meaningful and helpful means for the innovator to sort and identify the most valuable contributions to their innovations.

It is a further object and feature of the present invention to provide such innovation marketplace system that provides a means for innovators to communicate the challenges they face in developing their innovation to seek help with these challenges and (optionally) reward community members who helpfully respond to communicated challenges.

Another object and feature of the present invention is to provide such innovation marketplace system that permits community members to promote their innovations, skills, resources, organizations and companies to the innovation community.

A further object and feature of the present invention is to provide such innovation marketplace system that provides a helpful and detailed means to search and find in the innovation community specific types of innovations, skills, expertise, resources and needs.

It is a further object and feature of the present invention to provide such innovation marketplace system that provides community members (including groups and companies within the community) the ability to customize, initiate and manage innovation contests allowing the contest-owner to reward contest-takers for ranking existing innovations and/or for adding new innovations to the contest.

Yet another object and feature of the present invention is to provide such innovation marketplace system that provides an easy, convenient way for innovators to minimally, but sufficiently, communicate (and thus record for future development within the innovation marketplace) innovation concepts that occur to them at unexpected times and/or in unexpected circumstances.

Another object and feature of the present invention is to provide such an innovation marketplace system that provides integration and intercommunication with the broader social networking systems to facilitate the controlled communication between innovation marketplace members and those individuals and organizations outside of the innovation marketplace system which may also have innovations, skills, resources and relationships of value to the innovator and the innovation marketplace.

In addition, a further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a computer system, relating to at least one Internet based website primarily relating to serving users having skills, knowledge and/or resources relating to creation, development, protection, marketing, and/or monetization of inventions, comprising: access computer interface means for providing access to such computer system by such users; receiver computer interface means for receiving digital information, from such users, relating to at least one invention; invention computer storage means for assisting storing digital information relating to a plurality of such at least one inventions; and privacy computer processor means for assisting custom control of privacy relating to such at least one invention on behalf of each such user owning such at least one invention; wherein such privacy computer processor means comprises selectable-level computer processor means for assisting owner-user-selecting of at least one privacy level; and wherein such at least one invention may be controllably shared by each such user with others at such at least one level of privacy.

Moreover, it provides such a computer system wherein such privacy computer processor means further comprises information masking computer processor means for masking at least one user-selected portion of such digital information from view while disclosing the existence of such at least one user-selected portion of such digital information. Additionally, it provides such a computer system further comprising privacy contract computer processor means for assisting establishing at least one privacy contract relating to such masked at least one portion of such digital information. Also, it provides such a computer system wherein such privacy contract computer processor means comprises user-unmasking-request computer processor means for assisting requesting unmasking of masked such at least one portion of such digital information.

In addition, it provides such a computer system wherein such privacy contract computer processor means further comprises owning-user privacy contract selecting computer processor means for assisting owner-user-selecting at least one privacy contract. And, it provides such a computer system wherein such owning-user privacy contract selecting computer processor means comprises custom privacy contract receiving computer processor means for receiving at least one custom privacy contract. Further, it provides such a computer system wherein such privacy contract computer processor means further comprises user-selectable unmasking-request accepting computer processor means for assisting accepting unmasking requests of such masked at least one portion of such digital information.

Even further, it provides such a computer system further comprising privacy-contract-recording computer processor means for recording acceptance of such at least one privacy contract. Moreover, it provides such a computer system wherein such privacy-contract-recording computer processor means further comprises masked information access recording computer processor means for recording access to such masked at least one portion of such digital information. Additionally, it provides such a computer system wherein such privacy computer processor means further comprises secure encrypting computer processor means for securely encrypting transmissions of such digital information.

In accordance with another preferred embodiment hereof, this invention provides a computer system, relating to at least one Internet based website primarily relating to serving users having skills, knowledge and/or resources relating to creation, development, protection, marketing, and/or monetization of inventions, comprising: at least one access computer interface structured and arranged to provide access to such computer system by such users; at least one receiver computer interface structured and arranged to receive digital information, from such users, relating to at least one invention; at least one invention computer storage structured and arranged to assist storing digital information relating to a plurality of such at least one inventions; and at least one privacy computer processor structured and arranged to assist custom control of privacy relating to such at least one invention on behalf of each such user owning such at least one invention; wherein such at least one privacy computer processor comprises at least one selectable-level computer processor structured and arranged to assist owner-user-selecting of at least one privacy level; and wherein such at least one invention may be controllably shared by each such user with others at such at least one level of privacy.

Also, it provides such a computer system wherein such at least one privacy computer processor further comprises at least one information masking computer processor structured and arranged to mask at least one user-selected portion of such digital information from view while disclosing the existence of such at least one user-selected portion of such digital information. In addition, it provides such a computer system further comprising at least one privacy contract computer processor structured and arranged to assist establishing at least one privacy contract relating to such at least one user-selected portion of such digital information.

And, it provides such a computer system wherein such at least one privacy contract computer processor comprises at least one user-unmasking-request computer processor structured and arranged to assist requesting unmasking of masked such at least one user-selected portion of such digital information. Further, it provides such a computer system wherein such at least one privacy contract computer processor further comprises at least one owning-user-privacy-contract-selecting computer processor structured and arranged to assist owner-user-selecting at least one privacy contract. Even further, it provides such a computer system wherein such at least one owning-user-privacy-contract-selecting computer processor comprises at least one custom-privacy-contract-receiving computer processor structured and arranged to receive at least one custom privacy contract.

Moreover, it provides such a computer system wherein such at least one privacy contract computer processor further comprises at least one user-selectable unmasking-request accepting computer processor structured and arranged to assist accepting unmasking requests of such masked at least one user-selected portion of such digital information. Additionally, it provides such a computer system further comprising at least one privacy-contract-recording computer processor structured and arranged to record acceptance of such at least one privacy contract.

Also, it provides such a computer system wherein such at least one privacy-contract-recording computer processor further comprises at least one masked information access recording computer processor structured and arranged to record access to such masked at least one user-selected portion of such digital information. In addition, it provides such a computer system wherein such at least one privacy computer processor further comprises at least one secure encrypting computer processor structured and arranged to securely encrypt transmissions of such digital information.

In accordance with another preferred embodiment hereof, this invention provides a computer method, relating to at least one Internet based website primarily relating to at least one computer system serving users having skills, knowledge and/or resources relating to creation, development, protection, marketing, and/or monetization of inventions, comprising the steps of: providing access to such at least one computer system by such users; receiving digital information, from such users, relating to at least one invention; assisting storing digital information relating to a plurality of such at least one inventions; and assisting custom control of privacy relating to such at least one invention on behalf of each such user owning such at least one invention; wherein such step of assisting custom control comprises assisting owner-user-selecting of at least one privacy level; and wherein such at least one invention may be controllably shared by each such user with others at such at least one level of privacy.

And, it provides such a computer method wherein such step of assisting custom control further comprises masking at least one user-selected portion of such digital information from view while disclosing the existence of such at least one user-selected portion of such digital information. Further, it provides such a computer method further comprising the step of assisting establishing at least one privacy contract relating to such masked at least one portion of such digital information. Even further, it provides such a computer method wherein such step of assisting custom control comprises assisting requesting unmasking of masked such at least one portion of such digital information.

Even further, it provides such a computer method wherein such step of assisting custom control further comprises assisting owner-user-selecting at least one privacy contract. Even further, it provides such a computer method wherein such step of assisting owner-user-selecting comprises receiving at least one custom privacy contract. Even further, it provides such a computer method wherein such step of assisting custom control further comprises assisting accepting unmasking requests of such masked at least one portion of such digital information. Even further, it provides such a computer method further comprising the step of recording acceptance of such at least one privacy contract.

Even further, it provides such a computer method recording access to such masked at least one portion of such digital information. Even further, it provides such a computer method wherein such step of assisting custom control further comprises secure encrypting computer processor means for securely encrypting transmissions of such digital information. And, it provides for each and every novel feature, element, combination, step and/or method disclosed or suggested by this provisional patent application.

### BRIEF DESCRIPTION OF THE DRAWINGS

FIG. 1 shows a schematic diagram, illustrating an online innovation community, according to a preferred embodiment of the present invention.

FIG. 2 shows a schematic diagram, illustrating group utilization of such online innovation community, according to the preferred embodiment of FIG. 1.

FIG. 3 shows a graph diagram, illustrating multiple privacy levels with customization, according to the preferred embodiment of FIG. 2.

FIG. 4 shows a privacy assurance flow diagram, illustrating at least one privacy assurance method, according to the preferred embodiment of FIG. 1.

FIG. 5 shows an idea administration user-interface diagram, illustrating administrative functions available in at least one idea administration user-interface, according to the preferred embodiment of FIG. 1.

FIG. 6 shows an idea perusal user-interface diagram, illustrating idea interaction functions available in at idea perusal user-interface, according to the preferred embodiment of FIG. 1.

FIG. 7 shows a screenshot view, illustrating an authentication interface, according to the preferred embodiment of FIG. 1.

FIG. 8 shows a screenshot view illustrating one idea perusal user-interface of FIG. 6.

FIG. 9 shows a screenshot view, illustrating a user-interface, according to the preferred embodiment of FIG. 1.

FIG. 10A through FIG. 10E show screenshot views illustrating one idea administration user-interface of FIG. 5.

FIG. 11 shows a screenshot view, illustrating an authorization request interface, according to the preferred embodiment of FIG. 4.

FIG. 12 shows a screenshot view, illustrating an authorization interface, according to the preferred embodiment of FIG. 5.

### DETAILED DESCRIPTION OF THE BEST MODES AND PREFERRED EMBODIMENTS OF THE INVENTION

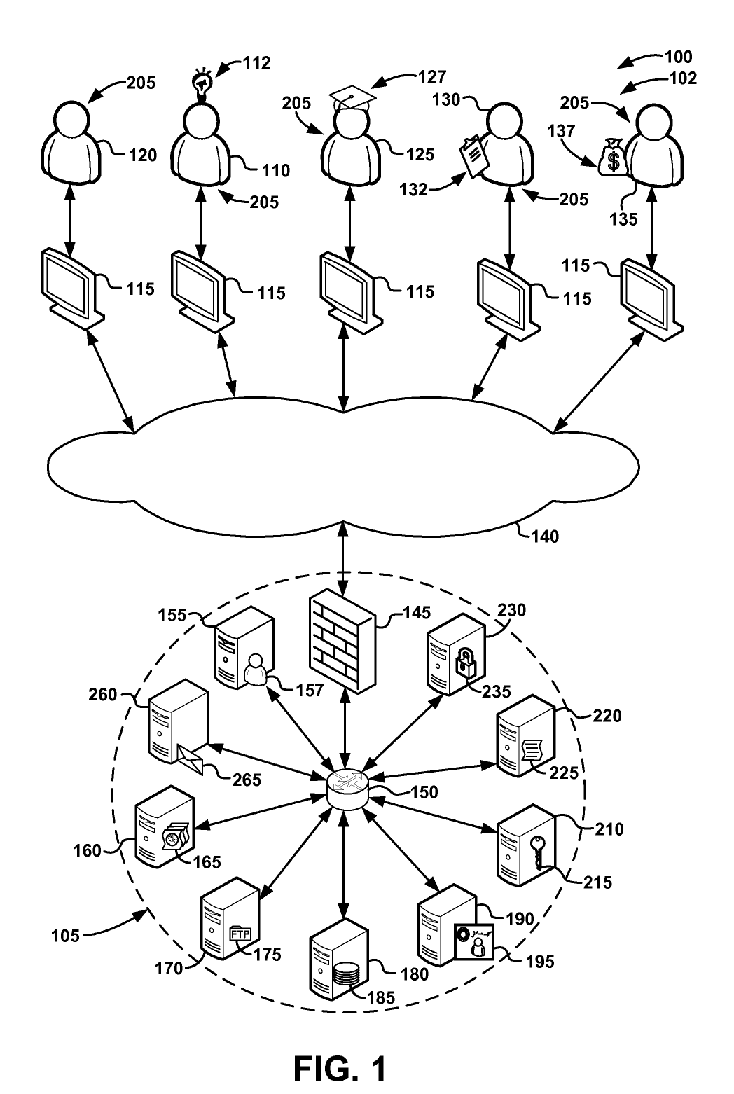

FIG. 1 shows a schematic diagram, illustrating an online innovation community 102, according to a preferred embodiment of the present invention. Innovation marketplace system 100 preferably comprises online innovation community 102, as shown. In the online innovation community 102, at least one user 205 gains access through Internet 140 to an online innovation community server environment 105, utilizing at least one Internet-enabled computerized device 115, as shown. Internet-enabled computerized device 115 preferably comprises at least one personal computer. Upon reading this specification, those skilled in the art will now appreciate that, under appropriate circumstances, considering such issues as future technology, cost, wide area network availability, etc., other Internet-enabled computerized devices, such as, for example, mobile computing devices, hand-held computing devices, internet-enabled phones, etc., may suffice.

User 205 preferably comprises, as shown, at least one system administrator 120, at least one innovator 110, at least one knowledgeable user 125, at least one skilled user 130, and at least one resource-bearing user 135. System administrator 120 preferably administrates online innovation community server environment 105. Upon reading this specification, those skilled in the art will now appreciate that, under appropriate circumstances, considering such issues as user interests, marketing, feedback needs, etc., other users, such as, for example, corporate idea hunters, parents, students, workers, etc., may suffice.

Innovator 110 preferably has at least one innovation idea 112, as shown, and preferably desires assistance from online innovation community 102 in furthering the development, marketing, protection and/or monetization of innovation idea 112. Innovator 110 preferably desires to initially maintain ownership rights while obtaining such assistance.

Knowledgeable user 125 preferably has knowledge 127 useful in assisting innovator 110 with innovation idea 112, as shown. Knowledge 127 preferably comprises technical knowledge in the area of innovation, practical knowledge from experience, and/or general knowledge pertaining to use. Knowledgeable user 125 preferably is willing to share knowledge 127 with online innovation community 102.

Skilled user 130 preferably has skills 132 useful in assisting innovator 110 with innovation idea 112, as shown. Skills 132 preferably comprise equipment skills, language skills, marketing skills, and/or implementation skills. Skilled user 130 preferably is willing to share skills 132 with online innovation community 102.

Resource-bearing user 135 preferably has resources 137 available to assist innovator 110 with innovation idea 112, as shown. Resources 137 preferably comprise monetary resources, connections to services, and/or physical resources. Resource-bearing user 135 preferably is willing to share resources 137 with online innovation community 102.

In online innovation community 102, innovation ideas 112, knowledge 127, skills 132, and resources 137 may preferably be exchanged in trade, for compensation, or freely as desired by involved users 205. Such compensation may be in real world monetary exchange or alternately in at least one intra-community virtual currency. Upon reading this specification, those skilled in the art will now appreciate that, under appropriate circumstances, considering such issues as cost, future exchange methods, future technologies, etc., other trade methods, such as, for example, inter-community virtual currency, integration with online currency exchanges, etc., may suffice. Upon reading this specification, those skilled in the art will now appreciate that, under appropriate circumstances, considering such issues as future technologies, user preferences, etc., other uses of intra-community virtual currency, such as, for example, monetary exchange, contest rewards, intra-site pay-per-click advertising, assistance bonuses, etc., may suffice.

Online innovation community 102 preferably provides personal and professional networking opportunities intended to bring together users having skills 132, knowledge 127 and/or resources 137, relating to the creation, development, protection, marketing, and/or monetization of innovation ideas 112, preferably while maintaining an environment capable of protecting ownership rights of innovator 110.

Online innovation community server environment 105 preferably provides services necessary to accomplish the objectives of online innovation community 102. Online innovation community server environment 105 preferably comprises, as shown, at least one user-authentication server 155, at least one user-interface server 160, at least one file server 170, at least one database server 180, at least one privacy-contract server 190, at least one privacy-rights server 210, at least one log server 220, at least one encryption server 230, and at least one messaging server 260.

Online innovation community server environment 105 preferably internally communicates through at least one communications router 150, as shown. Online innovation community server environment 105 preferably externally communicates through at least one firewall 145 to Internet 140, and thereby to users 205, as shown. Upon reading this specification, those skilled in the art will now appreciate that, under appropriate circumstances, considering such issues as cost, future technology, etc., other communications methods, such as, for example, other WAN communications, direct connections, etc., may suffice.

User-authentication server 155 (at least embodying herein access computer interface means for providing access to such computer system by such users; and at least embodying herein at least one access computer interface structured and arranged to provide access to such computer system by such users; and at least embodying herein providing access to such at least one computer system by such users) preferably maintains at least one user profile 157, as shown. User profile 157 preferably comprises at least one username-password combination, preferably designed to authenticate user 205 to online innovation community server environment 105. Once authenticated, user 205 receives permissions 215 from privacy-rights server 210.

User-interface server 160 preferably comprises at least one user interface 165 (at least embodying herein at least one receiver computer interface structured and arranged to receive digital information, from such users, relating to at least one invention; and at least embodying herein receiver computer interface means for receiving digital information, from such users, relating to at least one invention; and at least embodying herein receiving digital information, from such users, relating to at least one invention), as shown. User interface server 160 preferably utilizes permissions 215 to determine the information to display. Through user interface 165, user 205 preferably may alter user profile 157, and preferably participate in online innovation community 102.

Database server 180 (at least embodying herein assisting storing digital information relating to a plurality of such at least one inventions; and at least embodying herein at least one invention computer storage structured and arranged to assist storing digital information relating to a plurality of such at least one inventions; and at least embodying herein invention computer storage means for assisting storing digital information relating to a plurality of such at least one inventions) preferably comprises at least one database 185, as shown. Database 185 preferably stores information relating to innovation idea 112. Database 185 preferably comprises at least one relational database, and is preferably capable of maintaining relational information of innovation idea 112 as related to other information within online innovation community server environment 105.

File server 170 preferably is capable of receiving at least one file 175, relating to innovation idea 112, and preferably is capable of storing file 175, as shown. File server 170 preferably utilizes at least one file transfer protocol to send and receive file 175. File server 170 preferably utilizes database server 180 to link file 175 to related innovation idea 112.

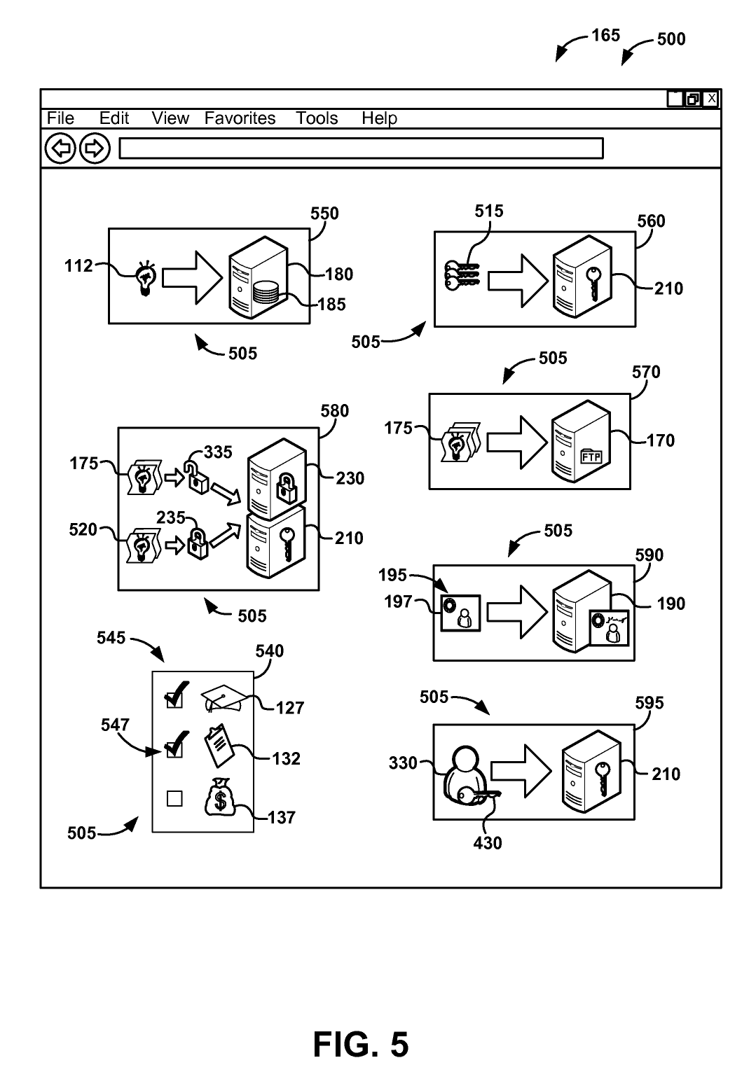

Privacy-contract server 190 preferably stores at least one privacy contract 195, as shown. Privacy contract server 190 preferably utilizes database server 180 to link privacy contract 195 to related innovation idea 112. When required privacy contract server 190 preferably provides privacy contract 195 to assist in establishing at least one privacy agreement between innovator 110 and user 205. Privacy contract server 190 preferably may receive at least one custom privacy contract 197 (see FIG. 5) from innovator 110 to use as privacy contract 195. Additionally, innovator 110 preferably may utilize privacy contract server 190 to select which privacy contract 195, if any, to utilize in connection with innovation idea 112.

Privacy-rights server 210 (at least embodying herein assisting custom control of privacy relating to such at least one invention on behalf of each such user owning such at least one invention; and at least embodying herein at least one privacy computer processor structured and arranged to assist custom control of privacy relating to such at least one invention on behalf of each such user owning such at least one invention; and at least embodying herein privacy computer processor means for assisting custom control of privacy relating to such at least one invention on behalf of each such user owning such at least one invention) preferably maintains permissions 215, as shown. Innovator 110 preferably may alter permissions 215 related to innovation idea 112 owned and/or controlled by innovator 110. Permissions 215 preferably comprise rights to access innovation idea 112. Permissions 215 preferably limit disclosure of innovation idea 112 as chosen by innovator 110.

Encryption server 230 preferably provides encryption to at least one locked file 520, as shown. Locked file 520 preferably resides in file server 170. When transmitting locked information 235 to user 205, encryption server 230 (at least herein embodying wherein such at least one privacy computer processor further comprises at least one secure encrypting computer processor structured and arranged to securely encrypt transmissions of such digital information; and at least herein embodying wherein such privacy computer processor means further comprises secure encrypting computer processor means for securely encrypting transmissions of such digital information; and wherein such step of assisting custom control further comprises securely encrypting transmissions of such digital information) preferably encrypts locked information 235, preferably preventing disclosure of innovation idea 112 during transmission. Upon reading this specification, those skilled in the art will now appreciate that, under appropriate circumstances, considering such issues as future technologies, cost, etc., other secure transmission methods, such as for example, establishing a VPN, establishing a direct connection, etc., may suffice.

Log server 220 preferably maintains at least one log 225, as shown. Log 225 preferably comprises information relating to privacy contract 195 being accepted and preferably information relating to access to locked information 235. Log 225 is preferably maintained to provide documentation of activities relating to locked information 235.

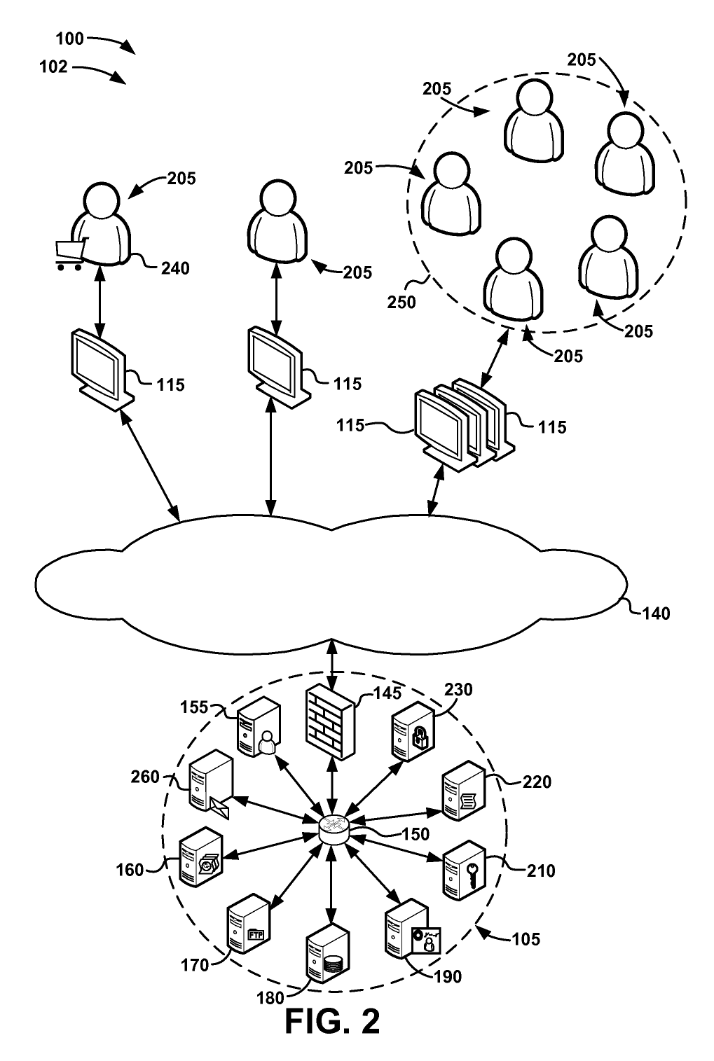

Messaging server 260 preferably permits at least one message 265 to be transmitted between at least two users 205, as shown. Messages 265 preferably may comprise authorization requests 415 (see FIG. 4), invitations to lease one group 250 (see FIG. 2), offers of assistance, requests for assistance, informational assistance, and/or system messages. Messaging server 260 preferably provides a communications channel useful in private and professional networking environments, such as online innovation community 102.

When utilized together, online innovation community server environment 105 preferably provides additional features comprising lists of friends, favorites, custom homepages, and other common-community features. Online innovation community server environment 105 provides these additional features to encourage active participation by all users 205 within online innovation community 102. As a unique social-market for innovation, online innovation community 102 preferably allows users 205 to securely share, develop and review each other's innovation ideas 112.

FIG. 2 shows a schematic diagram, illustrating group utilization of online innovation community 102, according to the preferred embodiment of FIG. 1. Online innovation community 102 preferably allows for the creation of groups 250, as shown. Groups 250 preferably comprise users 205, preferably collaborating on innovation idea 112. Innovator 110 may preferably form group 250 to include users 205, trusted by innovator 110, by invitation to participate in the development of innovation idea 112.

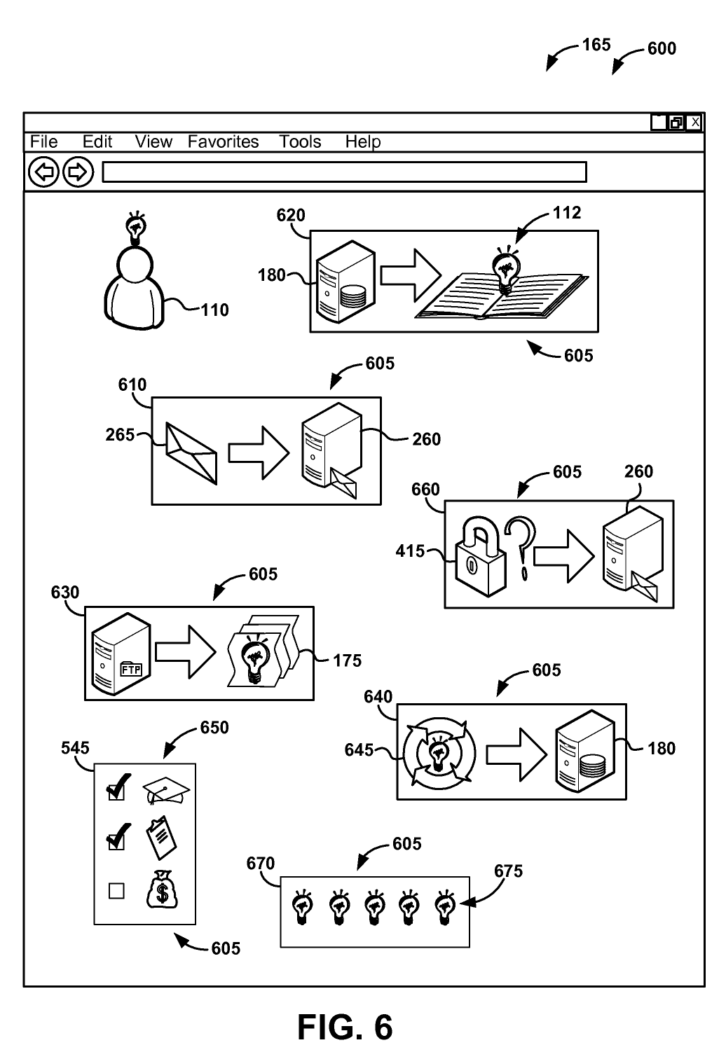

Likewise, groups 250 may preferably comprise at least one corporate group, formed to elicit feedback 645 (see FIG. 6) from users 205. Online innovation community 102 preferably drives corporate participation with private concept-testing and viral-marketing services. Group 250 preferably may tap into skills 132, knowledge 127, and/or resources 137 of online innovation community 102, particularly when users 205 within group 250 lack needed skills 132, knowledge 127, and/or resources 137.

In addition, group 250 may preferably receive feedback 645 from at least one potential consumer 240, as shown, from among users 205. By receiving feedback 645 from potential consumer 240, group 250 may utilize online innovation community 102 as a sounding board for the commercial viability of new ideas, preferably including innovation idea 112, alterations to marketing ideas, and/or new product lines.

Further, group 250 may preferably be formed to seek out well developed innovation ideas 112, whose innovators 110 are seeking licensing and/or sale of their respective innovation ideas 112. Group 250 may become well known in online innovation community 102 by users 205 within group 250 providing assistance to innovator 110 to bring innovation idea 112 to a state conducive to licensing and/or sale.

Online innovation community 102 preferably allows the best ideas from innovators 110, experts (knowledgeable user 125, skilled user 130, and resource-bearing user 135), groups 250, and potential consumers 240 to come together to grow.

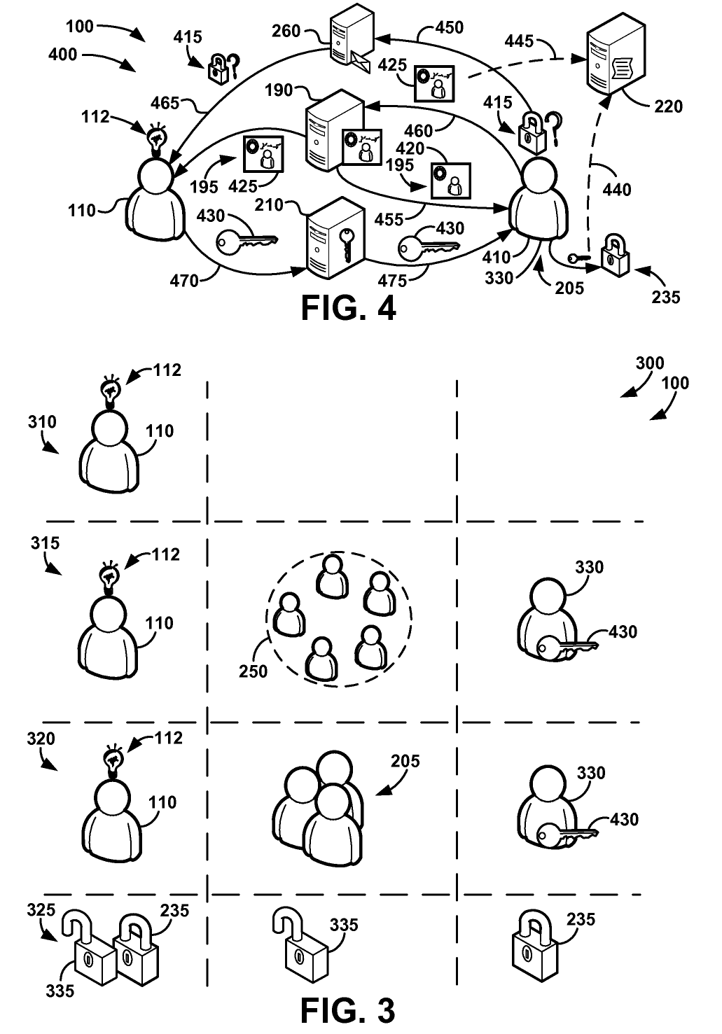

FIG. 3 shows a graphed matrix diagram, illustrating multiple privacy levels with customization 325, according to the preferred embodiment of FIG. 2. In order to provide assistance to innovator 110 and maintain privacy during development of innovation idea 112, privacy-rights server 210 preferably provides multiple levels of privacy for innovation idea 112, as shown in privacy matrix 300.

During the initial setup and development of innovation idea 112, innovator 110 preferably may choose to maintain complete privacy using privacy level 310. In privacy level 310, only innovator 110 may see any aspect of innovation idea 112, as shown. Innovator 110 may choose privacy level 310, while gathering together information pertaining to innovation idea 112, while exploring the viability of innovation idea 112, and/or while innovator 110 feels no need of outside assistance.

When innovator 110 wishes to share innovation idea 112 with a select group of users 205, innovator 110 preferably may choose privacy level 315, as shown. In privacy level 315, innovator of 110 preferably may invite select users 205, preferably to form group 250 with the purpose to further develop innovation idea 112. Privacy level 315 preferably allows innovator 110 to seek out users 205 with specific skills 132, knowledge 127, and/or resources 137, preferably without releasing information on innovation idea 112 to the general public.

Should innovator 110 wish to publicly disclose innovation idea 112 privacy level 320 is preferably available. Privacy level 320 preferably discloses innovation idea 112 to all users 205.

To provide customization 325 to privacy level 315 and privacy level 320, privacy-rights server 210 preferably further provides locking of portions of the information relating to innovation idea 112. Unlocked information 335 preferably is viewed according to the restrictions dictated by privacy level 315 or privacy level 320, preferably depending upon chosen setting of innovator 110. Locked information 235 (at least herein embodying wherein such at least one privacy computer processor further comprises at least one information masking computer processor structured and arranged to mask at least one user-selected portion of such digital information from view while disclosing the existence of such at least one user-selected portion of such digital information; and at least herein embodying wherein such privacy computer processor means further comprises information masking computer processor means for masking at least one user-selected portion of such digital information from view while disclosing the existence of such at least one user-selected portion of such digital information; and at least herein embodying wherein such step of assisting custom control further comprises masking at least one user-selected portion of such digital information from view while disclosing the existence of such at least one user-selected portion of such digital information), however, preferably may only be viewed at the discretion of innovator 110.

Innovator 110 preferably may individually approve users 205 to view locked information 235 by granting locked information access rights 430. Only users 205, having been granted locked information access rights 430 (access-granted users 330), may view locked information 235 whether privacy level 315 or privacy level 320 is selected.

Innovator 110 preferably may grant locked information access rights 430 for only one portion of locked information 235, alternately preferably for all portions of locked information 235. Innovator 110 preferably may select which portions of information relating to innovation idea 112 may be disclosed within selected privacy level, effectively allowing customization of both privacy level 315 and privacy level 320.

Innovator 110 always has access to both locked information 235 and unlocked information 335 no matter which privacy level (privacy level 310, privacy level 315 or privacy level 320) is chosen. Users 205 included in group 250 preferably may view any unlocked information 335, when privacy level 315 or privacy level 320 are chosen. All users 205 only have view privileges for unlocked information 335 when privacy level 320 is selected. For any user 205 other than Innovator 110, locked information 235 preferably requires locked information access rights 430 to be viewed.

Locked information 235 may preferably comprise at least one locked file 520 (see FIG. 5), related to innovation idea 112. Upon reading the specification, those skilled in the art will now appreciate that, under appropriate circumstances, considering such issues as future disclosure laws, cost, future technology, etc., other locked information, such as, for example, database fields, redacted information within a database field, redacted information in a file, etc., may suffice.

FIG. 4 shows a privacy assurance flow diagram, illustrating at least one privacy assurance method 400, according to the preferred embodiment of FIG. 3. When granting locked information access rights 430, innovator 110 may preferably desire to obtain assurance that access-granted users 330 will not disclose locked information 235. Online innovation community server environment preferably provides privacy assurance method 400 to assist in the assurance of nondisclosure, as shown.

When user 205 (shown as view requesting user 410) desires to view locked information 235, user 205 preferably submits at least one locked information view request 415 utilizing messaging server 260, as shown. Messaging server 260 preferably receives locked information view request 415, in step receive unlock request 450, as shown.

Innovator 110 preferably has selected privacy contract 195 to use in conjunction with innovation idea 112. Upon submission of locked information view request 415, privacy contract server 190 (at least embodying herein assisting establishing at least one privacy contract relating to such masked at least one portion of such digital information; and at least embodying herein at least one privacy contract computer processor structured and arranged to assist establishing at least one privacy contract relating to such at least one user-selected portion of such digital information; and at least embodying herein further comprising privacy contract computer processor means for assisting establishing at least one privacy contract relating to such masked at least one portion of such digital information) preferably provides privacy contract 195 as unsigned privacy contract 420, in step provide contract 455, as shown, to view requesting user 410. View requesting user 410 preferably submits privacy contract 195 as signed privacy contract 425, preferably to privacy contract server 190, as shown. Privacy contracts server 190 preferably receives signed privacy contract 425 in step receive signed contract 460, as shown.

Message server 260 preferably sends locked information view request 415 along with the status of privacy contract 195, preferably indicating a signed or unsigned state, in step forward view request 465, as shown. Upon receiving locked information view request 415, innovator 110 preferably elects to grant access rights 430 to view requesting user 410, preferably using privacy-rights server 210, in step grant access rights 470, as shown. Privacy-rights server 210 preferably provides access rights 430 to view requesting user 410, in step provide access rights 475, as shown, altering view requesting user 410 to become access-granted user 330. Access-granted user 330 preferably may then access locked information 235.

When user 205 submits signed privacy contract 425, log server 220 preferably logs signed privacy contract 425 in connection with user 205 and innovation idea 112, in step log signed contract 445. In addition, whenever access-granted user 330 accesses locked information 435, log server 220 logs such access in connection with user 205 and innovation idea 112, in step log access 440 (at least embodying herein recording access to such masked at least one portion of such digital information; and at least herein embodying wherein such at least one privacy-contract-recording computer processor further comprises at least one masked information access recording computer processor structured and arranged to record access to such masked at least one user-selected portion of such digital information; and at least herein embodying wherein such privacy-contract-recording computer processor means further comprises masked information access recording computer processor means for recording access to such masked at least one portion of such digital information). By logging both signed privacy contract 425 and access to locked information 435, innovator 110 may preferably obtain a record of all signed privacy contracts 425 and all disclosures of locked information 235 within online innovation community 102 from log server 220 (at least embodying herein further comprising at least one privacy-contract-recording computer processor structured and arranged to record acceptance of such at least one privacy contract; and at least embodying herein privacy-contract-recording computer processor means for recording acceptance of such at least one privacy contract; and at least embodying herein recording acceptance of such at least one privacy contract).

FIG. 5 shows an idea administration user-interface diagram, illustrating administrative functions available in at least one idea administration user-interface 500, according to the preferred embodiment of FIG. 1. User interface 165 preferably comprises idea administration user-interface 500, as shown. Idea administration user-interface 500 preferably provides innovator 110 with at least one administrative tool 505, as shown, for innovation idea 112.

Administrative tools 505 preferably comprise, as shown, at least one database interface 550, at least one privacy level interface 560, at least one privacy customization interface 580, at least one file upload interface 570, at least one privacy contract interface 590, at least one view authorization interface 595, and at least one options interface 540. Upon reading this specification, those skilled in the art will now appreciate that, under appropriate circumstances, considering such issues as, cost, future administration needs, future technologies, etc., other administrative tools, such as, for example, image editors, document drafters, spreadsheets, presentation tools, chat tools, etc., may suffice.

Database interface 550 preferably allows information relating to innovation idea 112 to be entered into database 185, as shown. Database interface 550 preferably allows creation, editing, and deletion of innovation idea 112 from database 185. Innovation idea 112 preferably is created within database 185 before other administrative tools 505 are activated.

Privacy level interface 560 (at least herein embodying wherein such at least one privacy computer processor comprises at least one selectable-level computer processor structured and arranged to assist owner-user-selecting of at least one privacy level; and at least herein embodying wherein such privacy computer processor means comprises selectable-level computer processor means for assisting owner-user-selecting of at least one privacy level; and at least herein embodying wherein such step of assisting custom control comprises assisting owner-user-selecting of at least one privacy level) preferably allows innovator 110 to set at least one privacy level 515 for innovation idea 112, as shown. By setting privacy level 515, innovator 110 is preferably allowed control over generally who has access to innovation idea 112, as discussed in FIG. 3. Privacy is preferably controlled by innovator 110, rather than being taken over by a corporate entity prior to allowing use of online innovation community 102. Innovator 110 preferably utilizes online innovation community 102 to ready innovation idea 112 to be licensed and/or sold, while preferably maintaining control of innovation idea 112. Settings of privacy levels 515 are preferably handled by privacy-rights server 210.

File upload interface 570 preferably provides access to file server 170, as shown. File 175 preferably may be uploaded and preferably connected to innovation idea 112. File upload interface 570 preferably uses at least one file transfer protocol. File 175 preferably provides additional information relating to innovation idea 112 beyond what may be entered into database 185 using database interface 550. File 175 preferably comprises images, alternately preferably specification documentation, alternately preferably plans. Upon reading this specification, those skilled in the art will now appreciate that, under appropriate circumstances, considering such issues as, file size, cost, future technologies, etc., other file types, such as for example, multimedia files, application files, charts, etc., may suffice.

Privacy customization interface 580 preferably allows customization of privacy levels 515, as shown. Files 175 preferably are set as locked files 520 (as indicated by locked information 235) when innovator 110 desires to limit viewing of files 175 to specific users 205. Any of files 175 that innovator 110 wishes to remain open to users 205 included in selection of privacy levels 515 may preferably be set to an unlocked state (as indicated by unlocked information 335). Locked file 520 preferably is encrypted by encryption server 230 to maintain security. Permissions to view locked information 235 and unlocked information 335 are preferably handled by privacy-rights server 210, preferably in conjunction with privacy levels 515, preferably creating privacy matrix 300 as described in FIG. 3.

Privacy contract interface 590 (at least herein embodying wherein such at least one privacy contract computer processor further comprises at least one owning-user-privacy-contract-selecting computer processor structured and arranged to assist owner-user-selecting at least one privacy contract; and at least herein embodying wherein such privacy contract computer processor means further comprises owning-user privacy contract selecting computer processor means for assisting owner-user-selecting at least one privacy contract; and at least herein embodying wherein such step of assisting custom control further comprises assisting owner-user-selecting at least one privacy contract)preferably provides innovator 110 with access to privacy contract server 190, as shown. Innovator 110 preferably may choose between privacy contracts 195 as provided by online innovation community 102, alternately preferably may choose to utilize at least one custom privacy contract 197. Privacy contract interface 590 (at least herein embodying wherein such at least one owning-user-privacy-contract-selecting computer processor comprises at least one custom-privacy-contract-receiving computer processor structured and arranged to receive at least one custom privacy contract; and at least herein embodying wherein such owning-user privacy contract selecting computer processor means comprises custom privacy contract receiving computer processor means for receiving at least one custom privacy contract; and at least herein embodying wherein such step of assisting owner-user-selecting comprises receiving at least one custom privacy contract) preferably allows uploading of custom privacy contract 197, as shown, alternately preferably allows entering of custom privacy contract 197. Using privacy contract interface 590, innovator may preferably assign privacy contract 195 to use upon request, of user 205, to view locked information 235.

Authorization interface 595 preferably allows innovator 110 to select individual users 205 to include in either privacy level 315 or as authorized to view locked information 235. Innovator 110 preferably may search and preferably add users 205 to privacy level 315. Further, upon receipt of authorization request 415, innovator 110 may preferably review user profile 157 of access-granted user 330, authorization request 415 and signed privacy contract 425. When innovator 110 chooses, innovator 110 may then preferably accept authorization request 415 using Authorization interface 595 (at least herein embodying wherein such at least one privacy contract computer processor further comprises at least one user-selectable unmasking-request accepting computer processor structured and arranged to assist accepting unmasking requests of such masked at least one user-selected portion of such digital information; and at least herein embodying wherein such privacy contract computer processor means further comprises user-selectable unmasking-request accepting computer processor means for assisting accepting unmasking requests of such masked at least one portion of such digital information; and at least herein embodying wherein such step of assisting custom control further comprises assisting accepting unmasking requests of such masked at least one portion of such digital information).

Options interface 540 preferably provides access to innovation idea options 545, as shown. Innovation idea options 545 preferably comprise at least one assistance request area 547. Assistance request area preferably comprises skills 132, knowledge 127, and/or resources 137. Innovation idea options 545 preferably are visible to users 205, and preferably indicate which areas innovator 110 would like assistance in relating to innovation idea 112. Upon reading this specification, those skilled in the art will now appreciate that, under appropriate circumstances, considering such issues as cost, future technologies, etc., other innovation idea options, such as, for example, stage of development, intellectual property applied, etc., may suffice.

Idea administration user-interface 500 preferably provides innovator 110 control over every aspect of developing, sharing, requesting aid in, and protectively disclosing innovation idea 112. Innovator 110 is preferably always in control.

FIG. 6 shows an idea perusal user-interface diagram, illustrating idea interaction functions available in at least one idea perusal user-interface 600, according to the preferred embodiment of FIG. 1. User interface 165 preferably comprises idea perusal user-interface 600. Idea perusal user-interface 600 preferably provides access to information relating to innovation idea 112 for user 205, as shown. Using idea perusal user-interface 600, user 205 may preferably interact with innovator 110 and other users 205 in providing assistance to innovator 110 relating to innovation idea 112. Idea perusal user-interface 600 preferably also indicates which user 205 is innovator 110, as shown.

Idea perusal user-interface 600 preferably comprises, as shown, at least one idea interaction function 605. Idea interaction function 605 preferably comprises at least one messaging interface 610, at least one information reading interface 620, at least one file access interface 630, at least one innovation idea feedback interface 640, at least one options display interface 650, at least one view access request interface 660, and at least one innovation idea rating interface 670. Upon reading this specification, those skilled in the art will now appreciate that, under appropriate circumstances, considering such issues as cost, future technologies, user preference, etc., other idea interaction functions, such as, for example, chat functions, white board functions, etc., may suffice.

Messaging interface 610 preferably provides access to messaging server 260, as shown. Messaging interface 610 preferably allows user 205 to send message 265 to other users 205. Message 265 preferably comprises information relating to innovation idea 112. Message 265 may preferably be sent to innovator 110. Message 265 preferably may also be sent to draw attention to innovation idea 112 from other users 205, provided users 205 have appropriate permissions 215. Messaging interface 610 preferably allows for private communication between users 205 relating to innovation idea 112.

Information reading interface 620 preferably displays information relating to innovation idea 112 stored in database 185, as shown. Information reading interface 620 preferably utilizes permissions 215 to determine which portions of information relating to innovation idea 112 are displayed for view by user 205. User 205 preferably reads information relating to innovation idea 112, and thereby preferably obtains an understanding of innovation idea 112.

File access interface 630 preferably provides access to file 175 using fileserver 170, as shown. Like with information reading interface 620, file access interface 630 utilizes permissions 215 to determine which of files 175 user 205 may access. File access interface 630 preferably allows downloading of file 175. File 175 preferably provides additional information relating to innovation idea 112 to extend understanding of innovation idea 112 to user 205.

View access request interface 660 preferably provides, as shown, user 205 the ability to make authorization request 415 (see FIG. 4). When innovator 110 has designated locked information 235, information reading interface 620 and/or file access interface 630 preferably displays that locked information 235 exists, however details of locked information 235 are hidden from view until user 205 receives access rights 430 from innovator 110. By showing that locked information 235 exists, user 205 understands that additional information is available relating to innovation idea 112. If user 205 desires to view the details of locked information 235, user 205 may utilize view access request interface 660 (at least herein embodying wherein such at least one privacy contract computer processor comprises at least one user-unmasking-request computer processor structured and arranged to assist requesting unmasking of masked such at least one user-selected portion of such digital information; and at least herein embodying wherein such privacy contract computer processor means comprises user-unmasking-request computer processor means for assisting requesting unmasking of masked such at least one portion of such digital information; and at least herein embodying wherein such step of assisting custom control comprises assisting requesting unmasking of masked such at least one portion of such digital information).

Innovation idea feedback interface 640 preferably allows user 205 to provide feedback 645 to innovator 110 relating to innovation idea 112, as shown. After user 205 utilizes information reading interface 620 and/or file access interface 630, user 205 preferably leaves feedback 645. Feedback 645 is preferably incorporated into information relating to innovation idea 112 stored in database 185. Feedback 645 preferably generates a free exchange of concepts and/or thoughts designed to assist innovator 110 with innovation idea 112.

Options display interface 650 preferably displays innovation idea options 545, as shown. Options display interface 650 preferably assists user 205 in identifying the needs of innovator 110 related to innovation idea 112, as shown. Options display interface 650 preferably prevents offers of assistance to innovator 110 in areas deemed unnecessary by innovator 110, preferably helping user 205 to focus on innovation ideas 112 where skills 132, knowledge 127, and/or resources 137 of user 205 are needed.

Innovation idea rating interface 670 preferably allows user 205 the ability to rate innovation idea 112, as shown. By rating animation idea 112, users 205 preferably promote innovation idea 112 for innovator 110. Innovation ideas 112 with higher ratings 675 preferably obtain higher prominence in online innovation community 102. Ratings 675 assist online innovation community 102 in focusing on innovation ideas 112 more likely to become fully developed and successful in the marketplace, as indicated by the popularity shown by ratings 675.

Idea perusal user-interface 600 preferably allows interaction of users 205 in online innovation community 102 to collaborate in the development of innovation idea 112 as controlled by innovator 110. Online innovation community 102 preferably uses peer-review (feedback 645 and ratings 675) to increase the predictability of success of innovation idea 112 and enable viral-marketing. And, because users 205 drive ratings 675 and popularity of innovation ideas 112, companies build relationships with consumers and discover concepts with demonstrated appeal and a ready market.

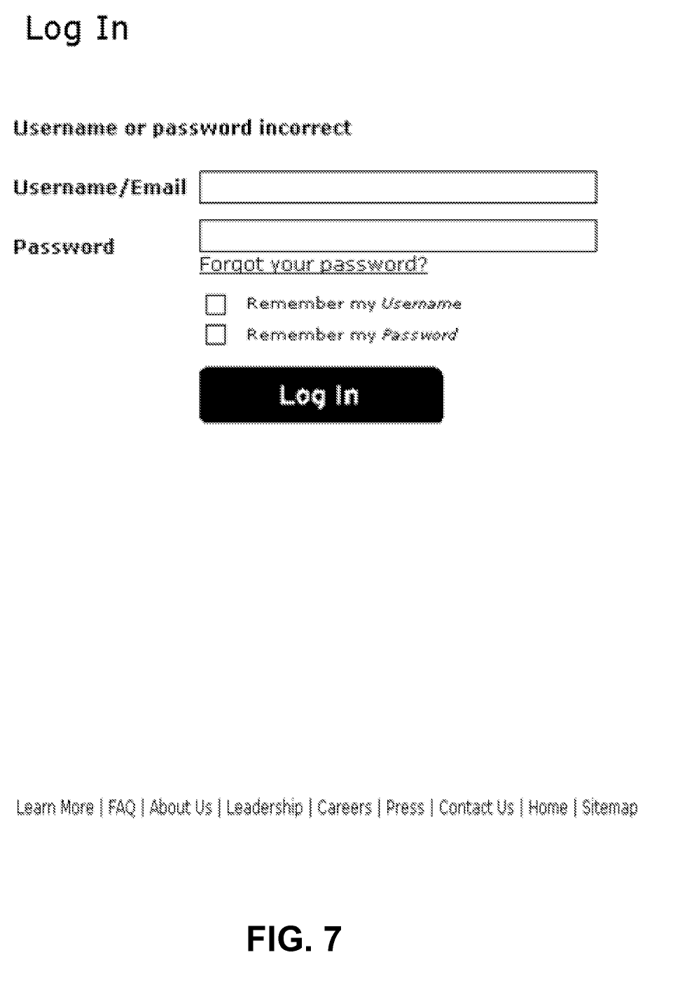

FIG. 7 shows a screenshot view, illustrating an authentication interface, according to the preferred embodiment of FIG. 1.

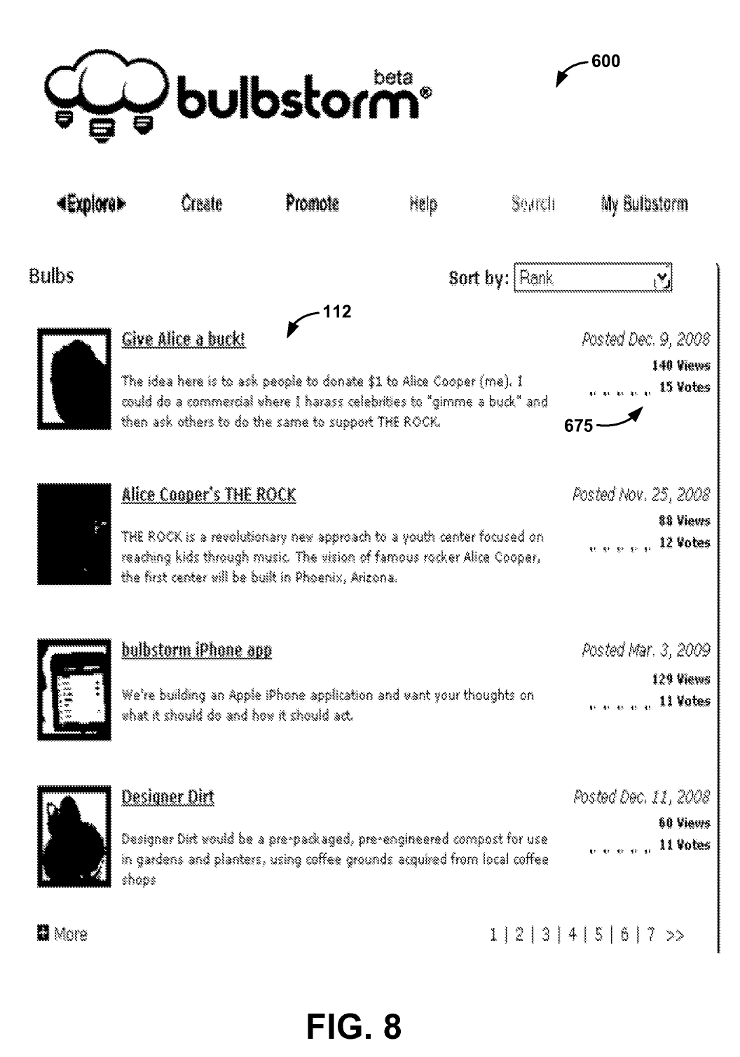

FIG. 8 shows a screenshot view illustrating one idea perusal user-interface of FIG. 6.

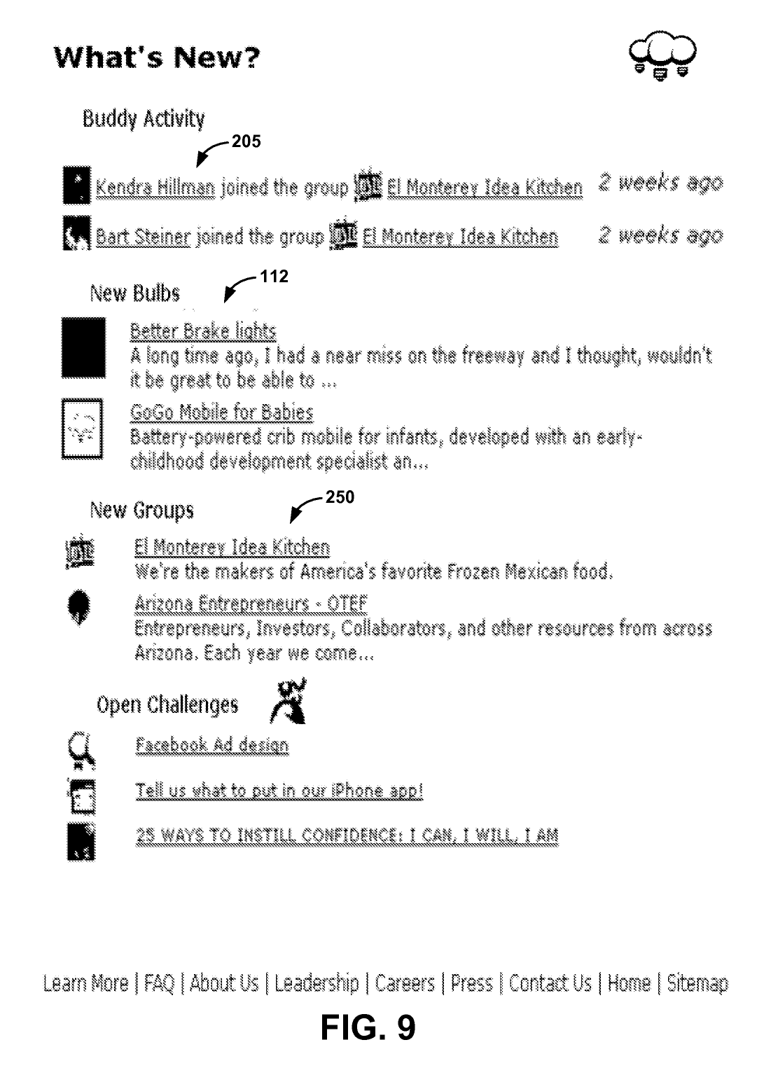

FIG. 9 shows a screenshot view, illustrating a user-interface, according to the preferred embodiment of FIG. 1.

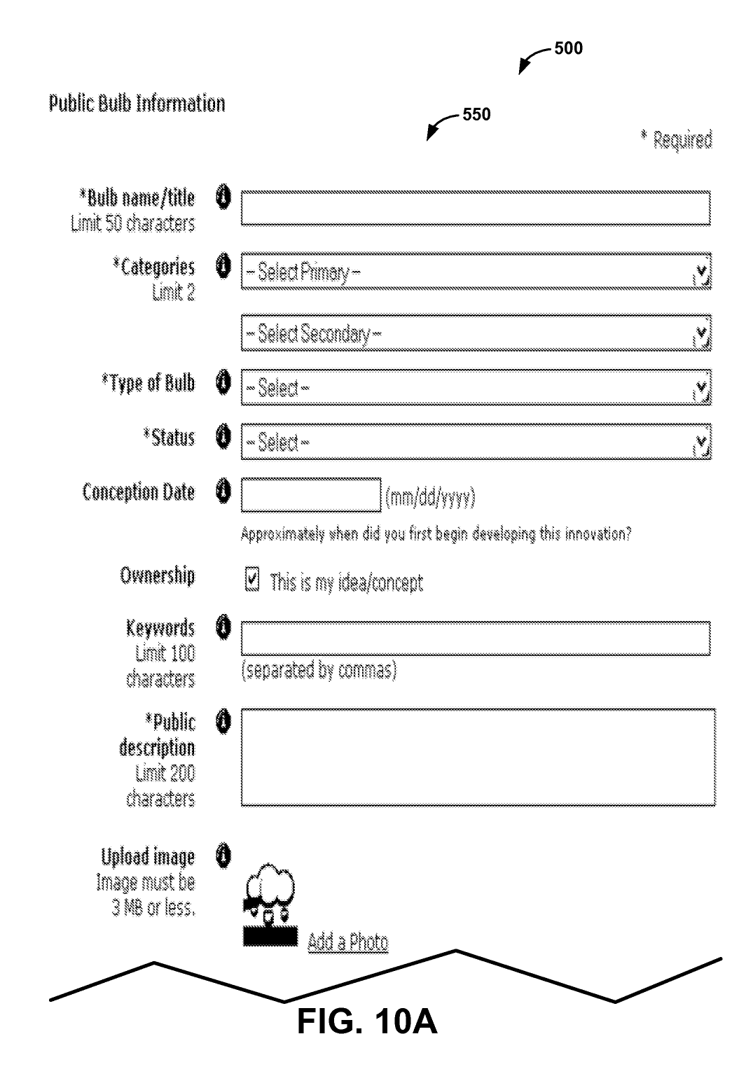

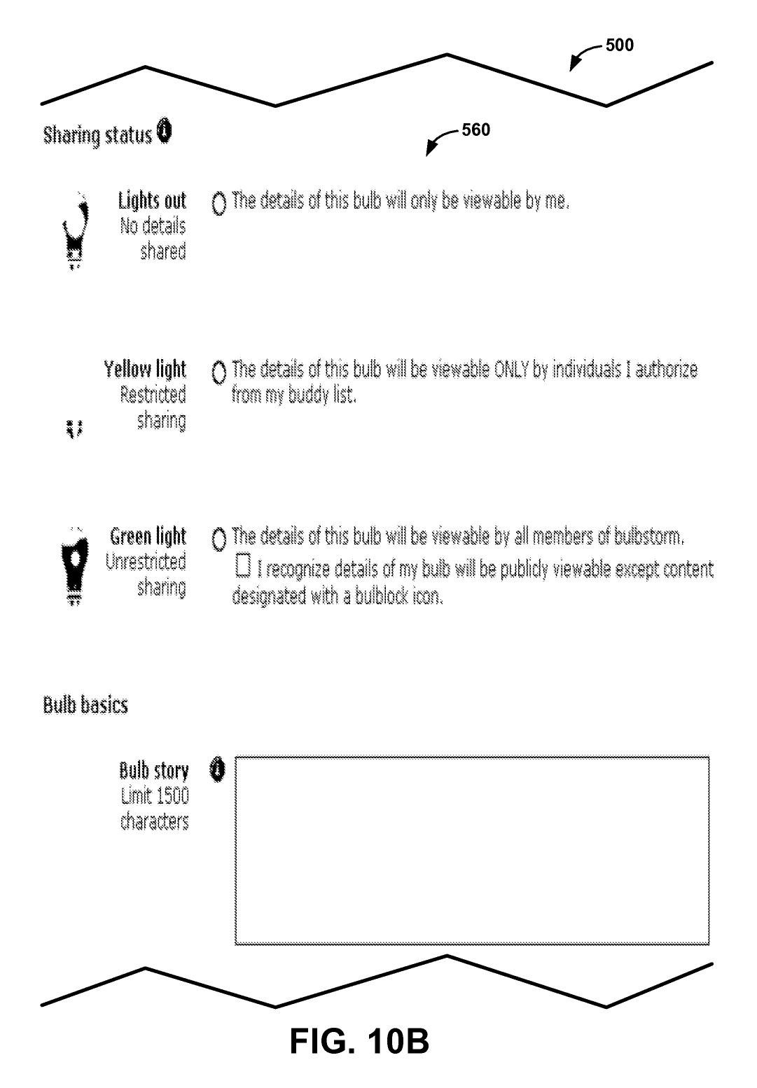

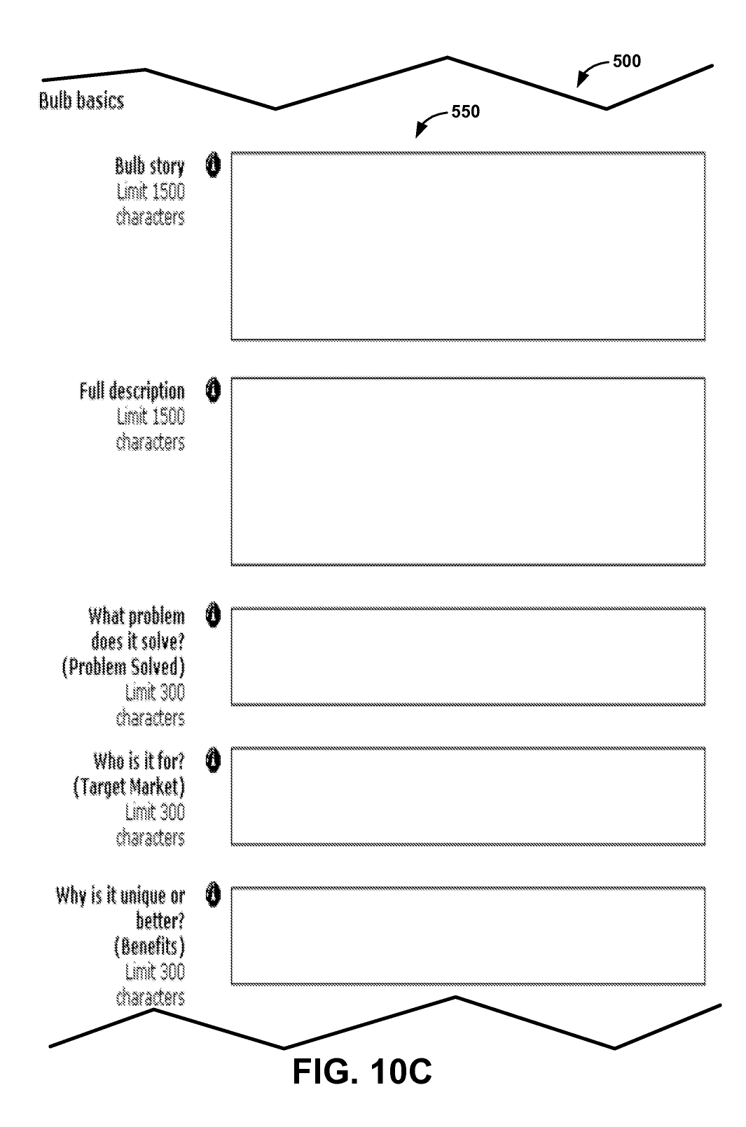

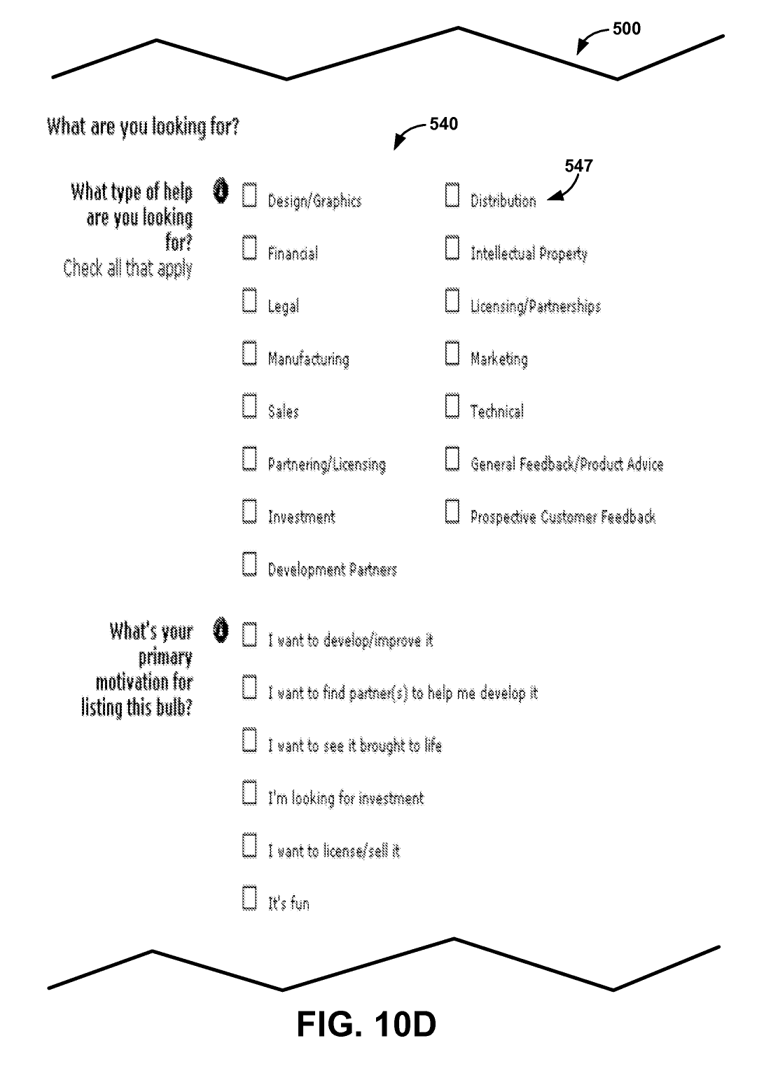

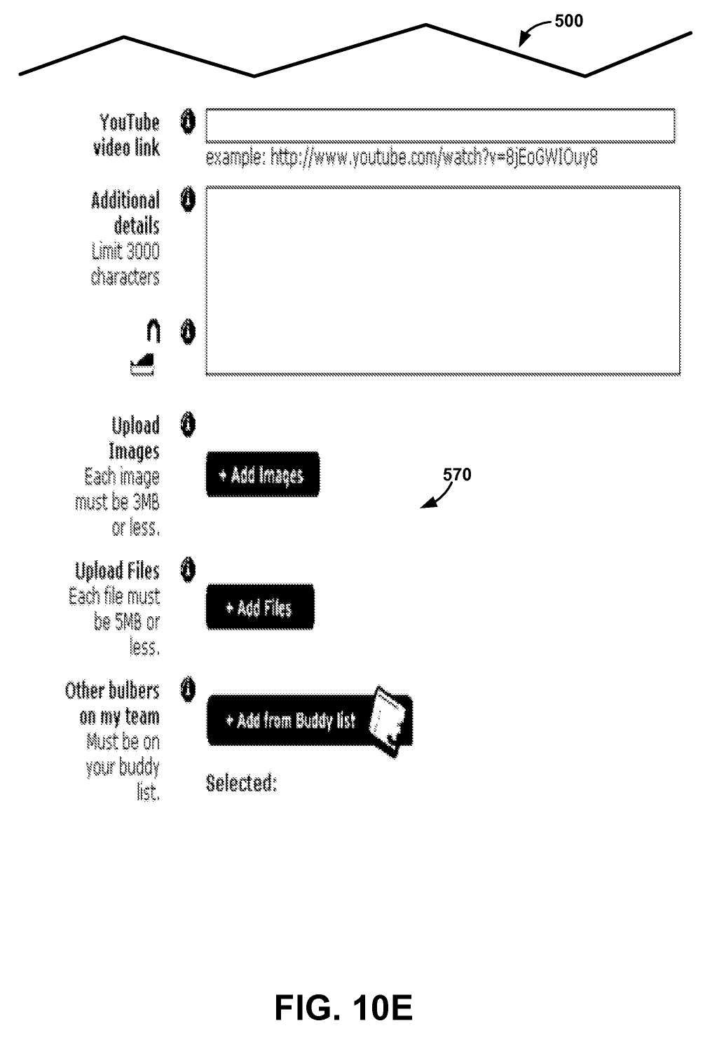

FIG. 10A through FIG. 10E show screenshot views illustrating one idea administration user-interface of FIG. 5.

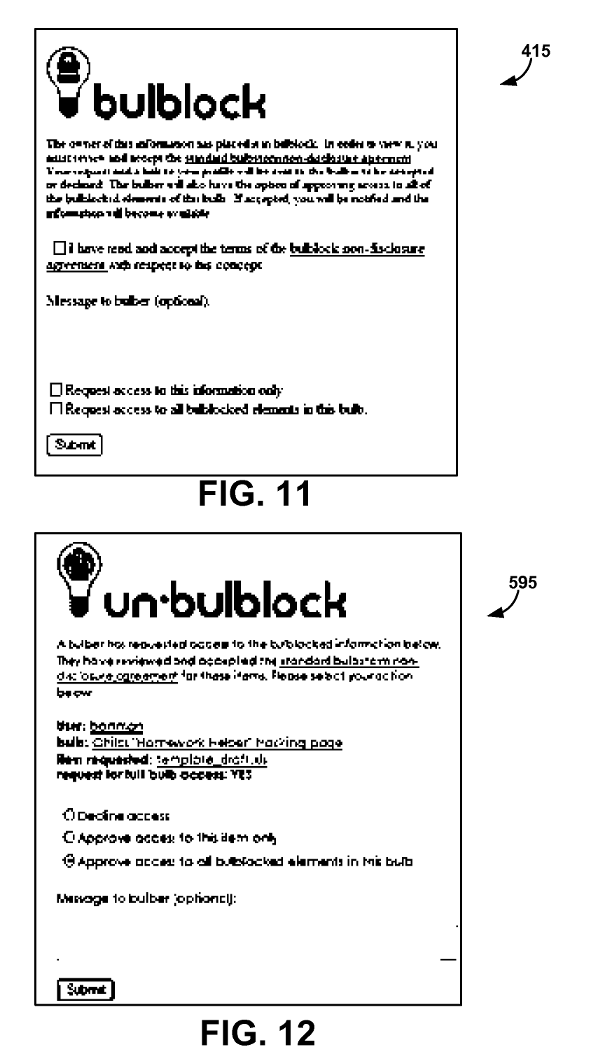

FIG. 11 shows a screenshot view, illustrating an authorization request interface, according to the preferred embodiment of FIG. 4.

FIG. 12 shows a screenshot view, illustrating an authorization interface, according to the preferred embodiment of FIG. 5.

FIG. 7 through FIG. 12 show screenshots of worked examples of user interfaces 165 utilized in online innovation community 102.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A computer system, relating to at least one Internet based website primarily relating to serving users having skills, knowledge and/or resources relating to creation, development, protection, marketing, and/or monetization of inventions, comprising:
a) access computer interface means for providing access to said computer system by such users;
b) receiver computer interface means for receiving digital information, from such users, relating to at least one invention;
c) invention computer storage means for assisting storing digital information relating to a plurality of such at least one inventions; and
d) privacy computer processor means for assisting custom control of privacy relating to such at least one invention on behalf of each such user owning such at least one invention;
e) wherein said privacy computer processor means comprises selectable-level computer processor means for assisting owner-user-selecting of at least one privacy level; and
f) wherein such at least one invention may be controllably shared by each such user with others at such at least one level of privacy.

2) The computer system according to claim 1 wherein said privacy computer processor means further comprises information masking computer processor means for masking at least one user-selected portion of such digital information from view while disclosing the existence of such at least one user-selected portion of such digital information.

3) The computer system according to claim 2 further comprising privacy contract computer processor means for assisting establishing at least one privacy contract relating to such masked at least one portion of such digital information.

4) The computer system according to claim 3 wherein said privacy contract computer processor means comprises user-unmasking-request computer processor means for assisting requesting unmasking of masked such at least one portion of such digital information.

5) The computer system according to claim 3 wherein said privacy contract computer processor means further comprises owning-user privacy contract selecting computer processor means for assisting owner-user-selecting at least one privacy contract.

6) The computer system according to claim 5 wherein said owning-user privacy contract selecting computer processor means comprises custom privacy contract receiving computer processor means for receiving at least one custom privacy contract.

7) The computer system according to claim 3 wherein said privacy contract computer processor means further comprises user-selectable unmasking-request accepting computer processor means for assisting accepting unmasking requests of such masked at least one portion of such digital information.

8) The computer system according to claim 3 further comprising privacy-contract-recording computer processor means for recording acceptance of such at least one privacy contract.

9) The computer system according to claim 8 wherein said privacy-contract-recording computer processor means further comprises masked information access recording computer processor means for recording access to such masked at least one portion of such digital information.

10) The computer system according to claim 3 wherein said privacy computer processor means further comprises secure encrypting computer processor means for securely encrypting transmissions of such digital information.

11) A computer system, relating to at least one Internet based website primarily relating to serving users having skills, knowledge and/or resources relating to creation, development, protection, marketing, and/or monetization of inventions, comprising:
a) at least one access computer interface structured and arranged to provide access to said computer system by such users;
b) at least one receiver computer interface structured and arranged to receive digital information, from such users, relating to at least one invention;
c) at least one invention computer storage structured and arranged to assist storing digital information relating to a plurality of such at least one inventions; and
d) at least one privacy computer processor structured and arranged to assist custom control of privacy relating to such at least one invention on behalf of each such user owning such at least one invention;
e) wherein said at least one privacy computer processor comprises at least one selectable-level computer processor structured and arranged to assist owner-user-selecting of at least one privacy level; and
f) wherein such at least one invention may be controllably shared by each such user with others at such at least one level of privacy.

12) The computer system according to claim 11 wherein said at least one privacy computer processor further comprises at least one information masking computer processor structured and arranged to mask at least one user-selected portion of such digital information from view while disclosing the existence of such at least one user-selected portion of such digital information.

13) The computer system according to claim 12 further comprising at least one privacy contract computer processor structured and arranged to assist establishing at least one privacy contract relating to such at least one user-selected portion of such digital information.

14) The computer system according to claim 13 wherein said at least one privacy contract computer processor comprises at least one user-unmasking-request computer processor structured and arranged to assist requesting unmasking of masked such at least one user-selected portion of such digital information.

15) The computer system according to claim 13 wherein said at least one privacy contract computer processor further comprises at least one owning-user-privacy-contract-selecting computer processor structured and arranged to assist owner-user-selecting at least one privacy contract.

16) The computer system according to claim 15 wherein said at least one owning-user-privacy-contract-selecting computer processor comprises at least one custom-privacy-contract-receiving computer processor structured and arranged to receive at least one custom privacy contract.

17) The computer system according to claim 13 wherein said at least one privacy contract computer processor further comprises at least one user-selectable unmasking-request accepting computer processor structured and arranged to assist accepting unmasking requests of such masked at least one user-selected portion of such digital information.

18) The computer system according to claim 13 further comprising at least one privacy-contract-recording computer processor structured and arranged to record acceptance of such at least one privacy contract.

19) The computer system according to claim 18 wherein said at least one privacy-contract-recording computer processor further comprises at least one masked information access recording computer processor structured and arranged to record access to such masked at least one user-selected portion of such digital information.

20) The computer system according to claim 13 wherein said at least one privacy computer processor further comprises at least one secure encrypting computer processor structured and arranged to securely encrypt transmissions of such digital information.

21) A computer method, relating to at least one Internet based website primarily relating to at least one computer system serving users having skills, knowledge and/or resources relating to creation, development, protection, marketing, and/or monetization of inventions, comprising the steps of:
a) providing access to such at least one computer system by such users;
b) receiving digital information, from such users, relating to at least one invention;
c) assisting storing digital information relating to a plurality of such at least one inventions; and
d) assisting custom control of privacy relating to such at least one invention on behalf of each such user owning such at least one invention;
e) wherein such step of assisting custom control comprises assisting owner-user-selecting of at least one privacy level; and
f) wherein such at least one invention may be controllably shared by each such user with others at such at least one level of privacy.

22) The computer method according to claim 21 wherein such step of assisting custom control further comprises masking at least one user-selected portion of such digital information from view while disclosing the existence of such at least one user-selected portion of such digital information.

23) The computer method according to claim 22 further comprising the step of assisting establishing at least one privacy contract relating to such masked at least one portion of such digital information.

24) The computer method according to claim 23 wherein such step of assisting custom control comprises assisting requesting unmasking of masked such at least one portion of such digital information.

25) The computer method according to claim 23 wherein such step of assisting custom control further comprises assisting owner-user-selecting at least one privacy contract.

26) The computer method according to claim 25 wherein such step of assisting owner-user-selecting comprises receiving at least one custom privacy contract.

27) The computer method according to claim 23 wherein such step of assisting custom control further comprises assisting accepting unmasking requests of such masked at least one portion of such digital information.

28) The computer method according to claim 23 further comprising the step of recording acceptance of such at least one privacy contract.

29) The computer method according to claim 28 recording access to such masked at least one portion of such digital information.

30) The computer method according to claim 23 wherein such step of assisting custom control further comprises securely encrypting transmissions of such digital information.
